(19) United States
(12) Patent Application Publication
(10) Pub. No.: US 2023/0413179 A1
(43) Pub. Date: Dec. 21, 2023

(54) FIELD DEVICE, EXPANSION MODULE AND METHOD FOR OPERATION

(71) Applicant: VEGA Grieshaber KG, Wolfach (DE)

(72) Inventors: Manfred Metzger, Haslach i.K. (DE); Roland Welle, Hausach (DE); Jörg Börsig, Schapbach (DE)

(21) Appl. No.: 18/253,351

(22) PCT Filed: Nov. 19, 2020
(86) PCT No.: PCT/EP2020/082653

§ 371 Date: May 17, 2023

(51) Int. Cl. H04W 52/02; H04W 64/00

(52) U.S. Cl. CPC H04W 52/0251; H04W 64/006; H04W 88/06

(57) ABSTRACT

A field device having radio communication devices for different radio networks and/or protocols and/or a radio communication device having different operating modes, a control device, and a position determining device. The control device activates one of the radio communication devices and/or an operating mode of the radio communication device according to position. The disclosed method of operation comprises switching on or activating the field device, determining a position a position of the field device, determining radio communication networks available at the position on the basis of the determined position of the field device, activating one of the radio communication devices and/or an operating mode of the radio communication device according to the determined position, transmitting and/or receiving data via the radio communication device, and switching off or deactivating the radio communication device and/or the field device.

### CROSS-REFERENCE TO RELATED APPLICATIONS

This application is a US National Phase of PCT Application Serial Number PCT/EP2020/082653 filed Nov. 19, 2020, which published as PCT Publication WO2022/106002, which is hereby incorporated by reference herein in its entirety.

### FIELD OF THE INVENTION

The present invention relates to a field device, a field device extension module and methods for operation of the aforementioned devices.

### BACKGROUND OF THE INVENTION

Well-known field devices in automation technology, in particular, process automation or also factory and/or logistics automation, are equipped and operated using different radio technologies.

The term automation technology is understood to mean a subfield of technology that includes all measures for the operation of machines and systems without human involvement. One goal of the associated process automation is to automate the interaction of individual components of a plant in the chemical, food, pharmaceutical, petroleum, paper, cement, shipping or mining sectors. For this purpose, a plurality of sensors can be used, which are particularly adapted to the specific requirements of the process industry, for example, mechanical stability, insensitivity to contamination, extreme temperatures and extreme pressures. Measured values from these sensors are usually transmitted to a control room, where process parameters, such as filling level, point level, flow rate, pressure or density can be monitored and settings for the entire plant can be changed manually or automatically.

One subfield of automation technology concerns logistics automation. With the help of distance and angle sensors, processes within a building or within a single logistics facility are automated in the field of logistics automation. Typical applications include, for example, logistics automation systems in the field of baggage and cargo handling at airports, in the field of traffic monitoring (toll systems), in retail, parcel distribution or also in the field of building security (access control). What the examples listed above have in common is that presence detection in combination with precise measurement of the size and position of an object is required by the respective application side. For this purpose, sensors based on optical measurement methods using lasers, LEDs, 2D cameras or 3D cameras that record distances according to the time of flight (ToF) principle can be used.

Another subfield of automation technology concerns factory/production automation. Applications for this can be found in a wide variety of industries such as automotive manufacturing, food manufacturing, the pharmaceutical industry or in general in the field of packaging. The aim of factory automation is to automate the production of goods by machines, production lines and/or robots, i.e., to allow them to take place without human intervention. The sensors used here and specific requirements with regard to the measurement accuracy in detecting the position and size of an object are comparable to those in the previous example of logistics automation. For this reason, sensors based on optical measurement methods are also usually used on a large scale in the field of factory automation.

Optical sensors have so far dominated both in the field of logistics automation as well as in the field of factory automation and security technology. These are fast (fast filling processes with >=10 measurements/second) and inexpensive and can reliably determine the position and/or distance to an object due to the optical radiation that can be focused relatively easily, on which optical radiation the measurement is based.

In process automation technology, field devices are often used to record and/or influence process variables. Examples of such field devices are level gauges, point level gauges and pressure gauges with sensors that record the corresponding process variables level, point level or pressure. Often, such field devices are connected to higher-level units, for example, control systems or control units. These higher-level units are used for process control, process visualization and/or process monitoring.

The term field device subsumes various technical facilities that are directly related to a production process. “Field” refers to the area outside control rooms. Field devices can therefore be actuators, sensors and transmitters in particular.

In particular, wired automation devices are widespread that can be wirelessly connected to a portable operator device, such as a smartphone for example, via a near-field interface (Bluetooth, Zigbee or others). In particular, this simplifies processes during startup or maintenance of the devices. In addition, there is a plurality of state-of-the-art automation devices that use a wireless interface for the continuous transmission of measured values or control signals to a second automation component. An important aspect here is to use radio technologies that can be operated with as little energy as possible and at the same time have a long range. On the basis of such technologies, it becomes possible to use wireless communication systems in automation devices, which can draw a limited amount of energy from their respective bus system.

On the basis of energy-saving radio communication technologies, self-sufficient systems have also recently become possible, which cover their energy requirements largely or entirely from an energy storage device integrated in the device, such as a battery for example. Such systems are characterized in that they are often used in mobile applications, for example in the form of sensors in logistics applications, thereby changing their respective place of operation at certain intervals.

### SUMMARY OF THE INVENTION

The present application also relates to self-sufficient measuring assemblies, in particular, self-sufficient level or point level sensors. The stand-alone level or point level sensors are preferably designed as radar sensors and—in order to ensure the self-sufficiency of the sensors—comprise a transmitting device for the transmission of recorded measurement data or measured values, preferably wirelessly, and their own power supply. The transmission device can preferably be a radio module for a narrowband radio technology (LoRa, Sigfox, LTE-M, NB-IoT), which transmits the measurement data or measured values to a cloud, i.e., to a server on the World Wide Web. The power supply is preferably designed as a battery or accumulator and can also include an energy harvesting module.

Typical application scenarios for such field devices include, in particular, inventory management or measurement tasks on mobile containers.

Known field devices of the aforementioned type have so far made it possible to transmit measured values in such a way that a higher-level unit triggers a specified action based on the determined measured value. For example, based on the measured value of a level measuring device, an inlet can be closed, or an outlet can be opened if a limit value is exceeded.

Self-sufficient field devices are characterized by a particularly simple installation without attaching a communication or power line and thus open up particularly flexible options for arrangement, i.e., in particular, their attachment in the process environment. A self-sufficient field device in accordance with the present application preferably comprises at least one sensor for detecting a process variable as well as sensor electronics, a radio module and a power supply.

The measured values determined by these field devices are typically transmitted to a cloud, i.e., to a server on the World Wide Web, using narrowband radio technology (LoRa, Sigfox, NB-IoT). Typical application scenarios for such field devices include areas such as flood forecasting, inventory management or also other decentralized measurement tasks.

In addition, there are expansion modules designed primarily for wired automation devices, which are inserted into specially designed expansion interfaces of the devices in order to expand them with wireless communication options. It can be provided that these expansion modules will include a plurality of wireless communication technologies. Furthermore, it can be provided to operate such expansion modules only temporarily, for example as part of a revision, in conjunction with a device, and then to install them in another automation device. As a result, the operating location also changes for such expansion modules, even if they are temporarily operated wired with an automation device, such as a sensor for example.

Wireless communication equipment for automation equipment has been gaining a great deal of importance in recent years. In the first few years, appropriately equipped devices supplied with sufficient power were primarily used to transmit measured values via a GSM mobile phone connection. Newer approaches are more likely to aim to connect sensors to a wearable device, such as a smartphone for example, via a near-field interface (e.g., Bluetooth) for ease of use. Completely new methods from the class of narrowband radio technologies (e.g., LoRa, Sigfox, NB-IoT, CAT-M) have recently made it possible to transmit measured values over long distances to a base station with a minimum of energy, making completely self-sufficient sensors possible in the first place.

A particular problem in the design of wireless communication devices for mobile applications is the selection of a suitable radio standard. If, for example, a mobile device is running with Sigfox technology, there can be a corresponding connectivity at a first location due to the presence of a Sigfox base station in the vicinity of the device. If, after a certain period of time, the device is moved to another location in the vicinity of which no Sigfox base station exists, for example in conjunction with a transportable container, the transmission of measured values regularly fails.

The corresponding correlations are quite similar for the narrowband radio technologies NB-IoT and CAT-M, which have been successively expanded by mobile phone providers. Depending on the respective mobile phone provider, there are regions in which connectivity is available exclusively via NB-IoT, and other regions in which associated networks are only available in the area of CAT-M technology.

In prior art, sensors are known that contain a plurality of radio technologies, for example, NB-IoT and CAT-M. Well-known solutions provide for the first implementation of connectivity using an initial standard during initial startup. If this fails, a second step is to try to implement connectivity using the second standard. As soon as connectivity can be implemented on one of the existing radio technologies, this radio standard will henceforth be defined as an active radio standard and shall not be discarded even if the corresponding network availability ceases to exist. Instead, an attempt is made to continuously scan the associated network channels and frequencies to achieve connectivity according to the radio standard used up until this point. As a result, massive amounts of power can be consumed.

It is the object of the present invention to provide a field device and an extension module for a field device which does not have the problems of prior art. Further, it is an object of the present invention to specify a method for operating such a field device as well as such an extension module.

A field device according to the invention with at least two different radio communication devices for different radio networks and/or protocols and/or at least one radio communication device with at least two different operating modes and with a control device is characterized by the fact that the field device comprises a position determination device, wherein the control device is designed in such a way that, depending on a determined position, one of the radio communication equipment and/or an operating mode of the radio communication device.

It is thus possible to determine a position, preferably a geographical position, or a position signal indicating the position of the field device and to activate the radio communication device at the position of the field device depending on the position or position signal and the availability and/or quality of a corresponding radio communication network. In this way, it is possible to avoid unnecessary connection attempts and to select the optimal radio communication network depending on the position.

Depending on the application, which radio communication network and thus which radio communication device is to be regarded as optimal can be determined, e.g., be dependent on a bandwidth, transmission speed, reliability, energy consumption or mere availability of a radio communications network or a combination of the above and possibly other criteria.

The position can be determined directly or indirectly. This means that a position determination can be carried out directly in the field device or indirectly via an available radio communication network and e.g., a service contacted via this service. For indirect position determination, the position signal(s) indicating a position of the field device are sent to the service, e.g., on a server on the Internet. This determines the position and transmits it back to the field device. In addition, or alternatively, the service can determine the availability of radio communication networks and transmit them to the field device so that it can select a possibly more suitable radio communication device for further communication.

In particular, the field device is a mobile field device, i.e., particularly field devices that are not installed or operated in a fixed location. Mobile field devices within the meaning of the present application are field devices that are either used on a mobile basis at various locations or field devices that are used on mobile carriers, e.g., mobile containers. Mobile containers are e.g., so-called IBCs (Intermediate Bulk Containers) or other transportable containers such as lorry-mounted silos and the like. For the purposes of the present application, the following shall be deemed transportable by customary means, e.g., industrial trucks, lorries and the same transportable containers.

It is a major aspect of the present invention to design a field device or an expansion module in such a way that it is set up to selectively activate one of at least two integrated wireless communication devices, depending on the respective place of operation, in order to exchange data with an external communication device via this device. It is also an aspect of the present invention to design a field device in such a way that it is set up to independently determine the wireless communication technology that can be used at the respective location and to store it in an integrated memory together with the respective location information. In addition, it can be regarded as an aspect to search the stored location information for the current position after the position has been determined, to determine the communication technology suitable for the current position and to activate the associated radio communication device to exchange data with a communication partner. This can save energy and greatly increase the runtime behaviour and/or service life of devices.

The combination of the information from the availability of the various radio networks and the position as well as any other information shall hereinafter also referred to as a network availability map or network coverage map. However, this terminology does not mean that it is a complete and pictorial map, but merely that the aforementioned information on the availability of the radio networks is linked to information on the position. The aforementioned terms shall be understood to mean any tabular or otherwise suitably structured and searchable link to the information.

The position determination device can, for example, be designed as a satellite-based position determination device. By means of such an embodiment of the position determination device, an absolute geographical position can usually be determined worldwide and used for the selection of the radio communication device. Examples include GPS, GLONASS and GALILEO as possible position determination devices.

In addition, or alternatively, the position determination device can be suitably designed to evaluate position data provided by a wireless network. Such data can be e.g., the availability and localization of WLAN signals in an individual location-dependent combination. These signals come from commercial hotspots, corporate networks, or private home networks. The knowledge of the location of these networks (routers) allows the calculation of the location. In this way, positioning can also take place in places where satellite signals are not available, e.g., in buildings.

In the context of the present invention, knowledge of the existence of a particular network (router), which is unambiguously identified by known parameters, for example an identifier periodically emitted by the network (MAC address or ID of the network), can also be understood as a position date. Thus, in particular, it can be provided that the position determination device determines a relative position to a characteristic location as an alternative or supplement to an absolute geographical position and uses this relative position according to the invention instead of or in addition to an absolute geographical position.

In other words, for example, it can be provided that the position determination device, following the detection of an identifier “CUSTOMER_WLAN”, determines an absolute geographical position “Freiburg” in order to activate one of the radio communication devices and/or an operating mode of the radio communication device on the basis of this absolute location, if applicable, using a publicly available network coverage map.

Alternatively or additionally, however, it can also be provided that the position determination device determines a relative geographical position “Customer No. 1” after recording an identifier “CUSTOMER_WLAN” in order to activate one of the radio communication devices and/or an operating mode of the radio communication device on the basis of this relative location, if applicable, using a non-public network coverage map. Thus, a determination of an absolute geographical position can be dispensed with.

A position detection device can therefore determine a position, wherein in the context of the present invention this is to be understood as an absolute geographic position and/or a relative position.

Suitable signals for determining an absolute or relative position can be e.g., Cellular, WLAN, LoRa, Sigfox, NB-IoT, or NFC signals that are received, for example, via a radio communication unit of the field device.

In an exemplary embodiment, an input and/or output scan of the field device or a container in a merchandise management system or the like, on the basis of which an input or output signal is transmitted to the radio communication unit, can also be used for absolute or relative positioning.

The radio communication devices can be selected from the group of radio communication modules that communicate in accordance with one of the standards WLAN, Bluetooth, Zigbee, NB-IoT, LoRa, Sigfox, CAT-M, Z-Wave and/or others. Self-sufficient field devices, in particular, self-sufficient sensors, gain additional application possibilities through the use of one or a plurality of the aforementioned radio standards. Self-sufficient sensors, i.e., field devices of this product family, are characterized by particularly simple installation without attaching a communication or power line. The measured values determined by these field devices are typically transmitted to a cloud, i.e., to a server on the World Wide Web, using narrowband radio technology (LoRa, Sigfox, NB-IoT). Typical application scenarios for such field devices include areas such as flood forecasting, monitoring of stormwater overflow basins, inventory management, measurement tasks on or in connection with mobile containers or also other decentralized measurement tasks.

In a preferred embodiment, the field device is set up to determine the availability of a radio communication network that can be connected by means of a radio communication device from the position data and to select one of the radio communication devices and/or an operating mode thereof according to the availability.

In other words, the information necessary for the selection of the radio communication device and/or the mode of operation of the same is fully available on the field device. In particular, the field device can store information about which of the possible radio network connections is available and preferred at which position. This can be e.g., through a database, table or map of (publicly) available accessible networks at the position within a memory of the field device. All publicly accessible radio network connections can be stored in the memory at the factory and, if necessary, supplemented by private radio network connections in operation of the field device and/or newly added public radio network connections.

According to the present application, the mode of operation of the radio communication device preferably includes at least one channel selection and/or a setting of a transmitting power and/or a setting of a radio protocol. By setting the operating mode accordingly, local conditions and/or regulations can be taken into account. For example, when using WLAN, the channel selection and the maximum permitted transmission power can be adapted to the respective national regulations. For example, the maximum transmission power in the 2.4 GHz band is limited to 100 mW in accordance with the IEEE 802.11 g and n, while in the USA a maximum transmission power of 1 W is permitted. Likewise, the permitted or recommended channels differ regionally.

In order to save energy for positioning, the field device can be set up to detect movement of the field device. In this way, it is possible to determine the position only when the field device is restarted and after a detected movement, i.e., when the position of the field device has changed, otherwise the last selected radio communication device or operating mode continues to be used. In this way, unnecessary position determinations and the associated energy consumption can be avoided.

It can be used to determine whether the field device remains stationary in a location or whether it is in motion. For this purpose, the field device can comprise one or a plurality of sensors that immediately indicate movement of the field device, such as an acoustic, optical and/or radar-based Doppler sensor, an acceleration sensor, a vibration sensor and/or a geomagnetic field sensor for example.

The field device is preferably designed as a self-sufficient field device and is therefore particularly mobile.

Another aspect of the present invention relates to a transportable container comprising a field device designed according to the above description. Mobile containers can be equipped particularly well with mobile and preferably self-sufficient field devices. In this context, it is an advantage that the self-sufficient field devices do not require connection cables and can often be operated with publicly available infrastructure. In particular, the above-mentioned narrowband radio technologies are often publicly available on a large scale, so that there are no additional costs for the operation and maintenance of a private infrastructure. Accordingly, mobile containers, e.g., so-called IBCs (Intermediate Bulk Containers) must already be equipped with a mobile field device, in particular, a self-sufficient level measuring device, which then only has to be integrated into the merchandise management system of the respective user, e.g., monitor the position and level of the container.

According to the invention, furthermore, an expansion module for a field device with at least two different radio communication devices for different radio networks and/or protocols and/or at least one radio communication device with different operating modes and with a control device, wherein the field device comprises a position determination device, wherein the control device is designed in such a way that, depending on a determined position, one of the radio communication equipment and/or select a mode of operation of the radio communication device.

An expansion module according to the invention can favourably be used, in particular, for modular field devices.

Modular field devices are made up of a modular field device concept. With a modular field device concept, a plurality of combinable sensors, housings, electronic units and operating and/or display units can be selected, and a corresponding field device can be set up. Such a modular field device concept is used, for example, offered by the company Vega Grieshaber KG. As a rule, a sensor, a corresponding electronic module that provides measured value processing and an interface to a controller and, if necessary, a fieldbus used, as well as various display and/or control units can be combined. The sensors, electronic modules and display and/or control units are adapted to each other as well as to different available housings.

The above-mentioned extension module is integrated into such a modular field device concept and thus opens up the possibility of equipping the field devices formed in this way, particularly, also existing field devices, with the functionality described above.

A method according to the invention for operating a field device according to the above description or a field device with an expansion module comprises the following steps:
switching on or activating the field device,
determining a position and/or a position signal indicating a position of the field device,
determining radio communication networks available at the position on the basis of the determined position and/or the position signal indicating the position of the field device,
activating a radio communication device and/or an operating mode of the radio communication device depending on the position determined,
transmitting and/or receiving data via the radio communication device, and
switching off or deactivating the radio communication device and/or field device.

The terms activation and deactivation do not mean that the field device is completely de-energized, but can also mean that the field device, components of the field device and/or the radio communication device are put into or woken up from an energy-saving mode.

In a favourable embodiment of the method, position signals of a satellite network are determined for position determination. In this way, the satellite networks mentioned above can be used to determine a global geographical position of the field device using simple means available on the market.

In addition, or alternatively, information from available radio communication networks can be determined for position determination. Due to the information available in various databases on radio communication networks, a position can often be determined less precisely, but also within buildings. In order to determine the information on the available radio communication networks, the respective radio communication unit must of course be activated. For this purpose, however, a purely passive operation is possible.

In the event that information on available radio communication networks is not available for either the determined position or the position signal, the availability of radio communication networks can be determined by activating at least one radio communication device and determining network availability. This will ensure that, according to the present notification, the field devices can also be operated in places for which no information is yet available.

In a variant of the method, the determined availability information is stored and/or transmitted to a higher-level unit. It is thus possible to supplement information stored in the field device and/or to successively complete the information available for all field devices.

This can be done in specifiable time periods or also on an ad hoc basis after new information has been saved. For example, the field device can upload the information to the available radio communication networks in the direction of a cloud, for example to an operator server, using a radio communication device. In the cloud, an analysis of the transmitted information on the available radio communication networks is carried out. In particular, newly included data points, which are not yet present in the cloud-managed network coverage map or cloud network coverage map, are used to extend the information merged in the cloud to the available wireless communication networks.

In addition to the determined availability of a radio communication network, a time of the determination can also be stored. In this way, it can be ensured, for example, that when the sensor reads out an entry stored at the current position, it can determine whether this entry can be outdated. If this is the case, a new search for available radio communication networks can be started. It can, for example, be provided to use entries of the information on the available radio communication networks, which contain a more recent time stamp compared to the corresponding entry, to transfer the information on the available radio communication networks in the higher-level unit, for example, the cloud. An update can also include deleting previously existing entries about the existence of a particular radio communication network if there was no network coverage at the corresponding position of the field device.

Furthermore, in addition to the determined availability, a reception strength of a signal of the radio communication network can be stored.

Especially in the case of battery-operated sensors, this information can be used during operation to select exactly the one that has the best reception strength for the respective location after the processor has requested a radio communication device. As a result, the message transmission can be particularly fast, which can save energy and thus increase the service life of battery-powered systems.

In a further embodiment, it can be provided for the selection device to be designed in such a way that the cost of telecommunications is taken into account in the selection of a radio communications facility. For example, if Bluetooth connectivity and NB-IoT connectivity are available, Bluetooth data transmission can be preferred, as it does not incur any transmission costs.

In a further embodiment, if there are a plurality of communication options, it can be provided that the energy requirement for a message transmission and/or the energy available in the device (state of charge of a battery) are taken into account in the selection. For example, if a plurality of networks are available, it can be provided to transmit a message preferably via LoRa instead of NB-IoT in order to save energy.

In order to optimize the energy consumption of the field device, the field device can detect movement of the field device and perform position determination and activation depending on the position only after switching on or activating after a detected movement. Otherwise, that means if the field device is not switched on or a previous movement has been detected, it is assumed that the field device remains at the place of activation and the previously used radio communication equipment and/or the previously used operating mode of the radio communication device continue to be used.

The present invention also relates to a computer program device for operating a field device or a field device with an expansion module as described above, which, when executed in a processor, causes it to carry out the method described above.

By means of a corresponding computer program code, it is possible to upgrade field devices that meet the hardware requirements by means of a software update for the present invention.

Preferred embodiments, features and properties of the proposed field device are the same as those of the proposed method and vice versa.

Favourable embodiments and variants of the invention result from the subclaims and the following description. The features listed individually in the subclaims can be combined in any technically reasonable manner with each other as well as with the features explained in more detail in the following description and can represent other favourable embodiment variants of the invention.

### BRIEF DESCRIPTION OF THE DRAWINGS

The present invention is explained in detail below by means of exemplary embodiments with reference to the attached figures. The figures show:

FIG. 1 a first exemplary embodiment of a field device in accordance with the present application,

FIG. 2 a further embodiment of the exemplary embodiment in FIG. 1,

FIG. 3 a method for operating a field device in accordance with FIGS. 1 and 2.

In the figures, unless otherwise stated, the same reference numbers denote the same or corresponding components with the same function.

### DETAILED DESCRIPTION OF THE DRAWINGS

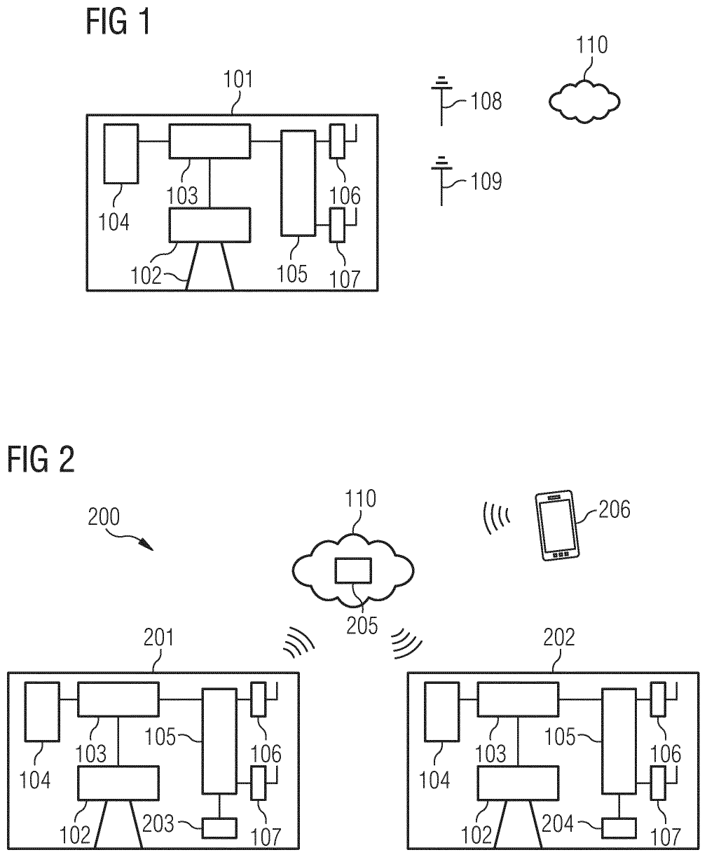

FIG. 1 shows a first exemplary embodiment of a field device 101 according to the present application.

In the present case, the field device 101 is designed as a self-sufficient level sensor. The level sensor 101 comprises a data acquisition device 102, a control device 103 designed as a processor, a position determination device 104, a selection unit 105 as well as a first radio communication device 106 and a second radio communication device 107. The components of the field device 101 can obtain their energy required for operation preferably from an power source (not shown here) integrated in the field device 101, such as a battery for example.

The first radio communication device 106 is designed as an NB-IoT (narrow-band IoT) modem and is equipped for message exchange with a first external communication device 108, for example an NB-IoT base station or an NB-IoT transmission tower, which can be located in the vicinity of the field device 101.

The second radio communication device 107, for example, a CAT-M modem, is equipped for message exchange with a second external communication device 109, such as a CAT-M base station or a CAT-M transmission tower for example, which can be located in the vicinity of the sensor 101. It can also be provided that at least one of the radio communication devices 106, 107 implements local communication over a short distance using private network technologies, for example via Bluetooth, Zigbee or WLAN. The associated external communication device is then implemented by a base station (WLAN router) or a mobile operator device (smartphone, tablet) available at the operator's premises.

The processor 103 can be designed with the involvement of a data acquisition device 102 to determine at least one value of a physical quantity in the vicinity of the field device 102, and to make it available to the outside world using the first radio communication device 106 or the second radio communication device 107, for example by transmission to an external communication partner 110, for example, a server 110 or a cloud 110. The selection unit 105 is designed to determine a wireless communication technology that can be used at the respective location or position and can be integrated into the control device 103 or the processor 103, respectively. For this purpose, the selection unit 105 receives the current position from the position determination unit 104.

In a first exemplary embodiment, the selection unit 105 then activates the first or second radio communication unit 106, 107 according to a specifiable or factory-specified set of rules. For example, it can be possible to activate a LoRa communication unit at a specific position on a factory site, and an NB-IoT communication unit at a specific position outside a factory site.

In a second exemplary embodiment, the selection unit 105 is alternatively or additionally designed in such a way as to use a coverage map stored in an internal memory ex works (hereinafter also referred to as the network availability map), which contains information on the availability of different radio technologies (WLAN, Bluetooth, Zigbee, NB-IoT, LoRa, Sigfox, CAT-M and/or others) at a plurality of locations. In combination with the position determination device 104 and the processor 105, the current operating location of the field device 101 can be determined and, using the internally stored coverage map, it can be verified whether the first radio communication device 106 or the second radio communication device 107 is to be connected to the processor 103 for the transmission of messages.

In further embodiment, the selection device 105 can be designed to learn the coverage map independently and to expand it continuously. If, following a request by processor 103 to activate a radio communication device 106, 107, the selection device 105 determines that there is no information contained in the coverage map for the location currently determined by the position determination device 104, it can be designed to first attempt to transmit the messages via the first radio communication device 106. If this is successful, the coverage map at the determined location can be expanded to include information on the availability of the first radio communication technology. If this does not succeed, the evaluation device 105 can activate the second radio communication device 107 in order to attempt a new transmission attempt for the message of the processor 103. If the message can be transmitted successfully, the coverage map in sensor 101 can be updated accordingly.

The aforementioned mechanisms can also be used for a third and further radio communication equipment integrated in the sensor and are by no means limited to mobile radio applications. In particular, it can be provided to integrate a LoRa communication unit and an NB-IoT and a CAT-M communication unit into a field device 101, and to specify the network availability map for all or part of the integrated technologies in whole or in part ex works and/or to have it created and/or extended independently by the sensor.

It can be provided, in addition or alternatively, that a user can modify or supplement the network availability map by making appropriate manual entries on a user interface. As a result, energy-intensive scans using the radio communication equipment 106, 107 can be avoided or reduced.

It can also be provided that part or all of the data points in the network availability map will be stored at the time of the last update. In this way, it can be ensured, for example, that the sensor can determine whether this entry can be outdated when reading an entry stored at the current position from the network availability map. If this is the case, a new search for available radio communication networks can be started using the devices 106, 107.

It can be provided to store the power availability card in a non-volatile memory in order to make it available again in the event of a complete deactivation or complete shutdown of the electronics and subsequent restart.

It can also be provided to determine the reception strength of a signal to an available radio communication technology and to store it in the network availability map. Especially in the case of battery-operated sensors, this information can be used during operation to select exactly the one that has the best reception strength for the respective location after a radio communication device 106, 107 has been requested by the processor 103. As a result, the message transmission can be particularly fast, which can save energy and thus increase the service life of battery-powered systems.

With the continuous expansion of wireless communication networks, the possibility of realizing a message transmission using both the first radio communication device 106 as well as the second radio communication device 107 arises in some locations using an automation device according to the invention. Corresponding information can be contained in a network availability map.

In a further embodiment, it can be provided that the selection device 105 is designed in such a way that it takes into account the costs of communication in the selection of a first or second radio communication device 106, 107. For example, if Bluetooth connectivity and NB-IoT connectivity are available, Bluetooth data transmission can be preferred, as it does not incur any transmission costs. In further embodiment, if there are a plurality of communication options, it can be provided to take into account the energy requirements for a message transmission and/or the energy available in the device (state of charge of a battery) in the selection. For example, if a plurality of networks are available, it can be provided to transmit a message preferably via LoRa instead of NB-IoT in order to save energy. Furthermore, it can be possible to select between two alternatively available radio communication technologies depending on the respective reception strength at the position of the sensor. This can increase the reliability of a message transmission.

In further embodiment of a sensor, it can be provided to activate at least one of the available wireless communication technologies 106, 107, for example a Bluetooth technology, only at a certain position in one's own company. This ensures that a change in sensor classifications or an update of the software can only take place within the company's own company and not after delivery to third-party companies. This can improve the IT security of the sensor.

FIG. 2 shows a further embodiment of the exemplary embodiment from FIG. 1. The exemplary embodiment shown above with a network availability map for the availability of location-dependent, different radio communication technologies that can be specified within the sensor and/or learned by the sensor itself can be further improved with the inclusion of a cloud 110.

A first sensor 201 builds a network availability map 203 according to one of the methods proposed above. In specifiable time periods or also on an ad hoc basis after a new data point has been entered into the network availability map 203, the sensor 201, initiated by a program element of the processor 103, can upload the network availability map 203 in the direction of a cloud 110, for example, an operator server 110, using one of the radio communication devices 106, 107. In the cloud 110, an analysis of the transmitted network availability map 203 is carried out. In particular, the new data points included in the network availability map 203, which do not yet exist in the cloud network availability map 205, are used to extend the network availability map 205 in the cloud 110.

Furthermore, it can be provided to use entries of the network availability map 203, which contain a newer timestamp compared to the corresponding entry of the cloud network availability map 205, to update the cloud network availability map 205. An update can also include deleting previously existing entries about the presence of a particular communication network if there was no network coverage at the corresponding position of the sensor.

In a further method step, it can be provided to transmit the network availability map 205 to a second sensor 202 in the case of existing connectivity. The second sensor 202 can use the information of the transmitted cloud network availability map 205 according to the principles already disclosed to partially or fully update its own network availability map 204. In this way, it can be ensured and achieved that network coverage information independently acquired by any sensor 201 or network coverage information entered at any sensor 201, 202 or an operator device 206 connected to the cloud 110 is transmitted to all units connected to the system 200, whereby all components involved can be equally improved in their respective operating procedures.

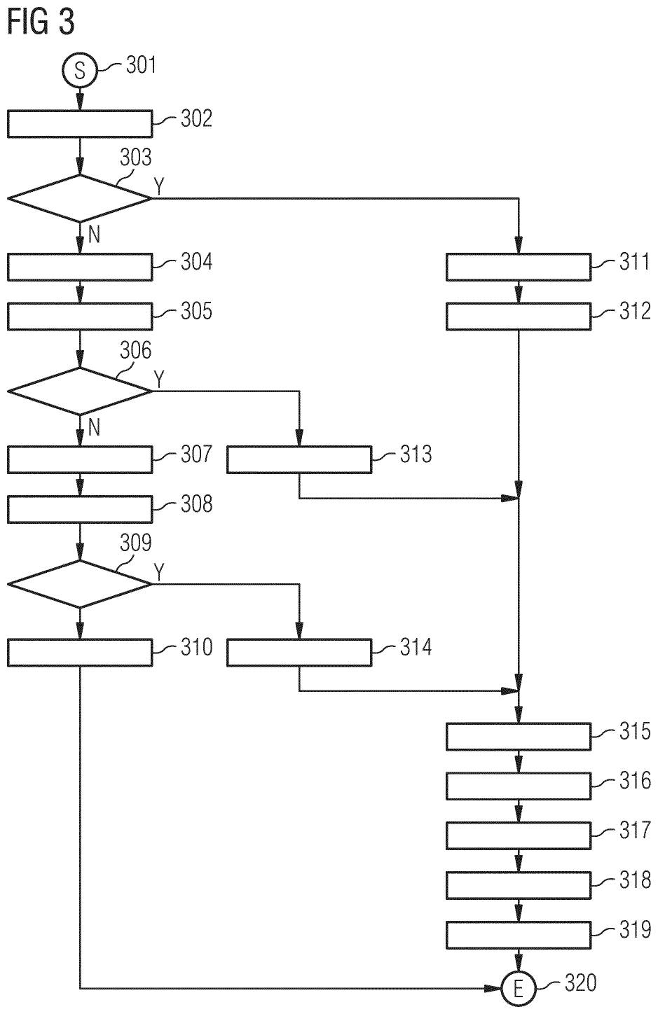

FIG. 3 shows an exemplary method for operating a field device 101, 201, 202 both stand-alone as well as in conjunction with the cloud 110 described in FIG. 2.

The method begins in the startup state 301, for example, when a data transmission is requested by the processor 103 or after a change in the position of the field device 101, 201 or as specified by a user.

At step 302, the current position of the field device 101 is determined. For example, GPS sensors 104 can be used for this purpose. In addition, the network availability card 203 is loaded.

At step 303, the selection device 105 uses the network availability map 203 to verify whether the first radio communication device 106 or the second radio communication device 107 is capable of transmitting messages at the current position. If this is the case, at step 311 the respective communication device 106, 107 is activated in accordance with the entry of the network availability card 203, and at step 312 a message is transmitted in the direction of an external communication device 108, 109, 206.

Otherwise, step 304 searches for available radio communication networks by activating the first radio communication device 106. At step 305, a message is transmitted via the first radio communication device 106, whereupon at step 306 it is verified whether this could be done successfully. If this is the case, at step 313, the network availability map 204 is updated with the information of the radio technology of the first communication device 106 and the current position.

Otherwise, the second radio communication device is activated at step 307, whereupon a message is transmitted via the second radio communication device 107 at step 308. Step 309 verifies that the submission was successful. If this is the case, at step 314, the network availability map 204 is updated with information about the absence of network coverage belonging to the first radio communication device 106 at the current location and the presence of network coverage belonging to the second radio communication device 107 at the current position.

Otherwise, at step 310, the network availability map 204 is updated with the information that there is no network coverage belonging to either the first or the second radio communication device 106, 107 at the current location. In this case, the method ends in the final state 320 without a message being able to be transmitted.

If, on the other hand, a message could be transmitted, the optional steps 315 to 318 can be processed in an event-driven or time-controlled manner or be processed in a manner that can be specified in accordance with user input.

At step 315, the network availability card 204 of the field device 101, 201 is transferred to a cloud 205.

At step 316, the cloud 210 or a program element running on a server connected to the cloud 210 updates the cloud network availability map 205 using the information from the network availability map 203 transmitted by the field device 201. At step 317, the updated cloud network availability map 205 is transmitted back to another field device 202 or a plurality of field devices, wherein in one embodiment, only locally valid parts of the complete cloud network availability map 205, which contains information from the environment of the respective field device 201, 202, can also be transmitted. This can save data volume and energy.

At step 318, the network availability map 204 of the sensor 202 is updated using the transmitted information 205. At step 319, all radio communication devices 106, 107 are deactivated before the method ends at step 320.

It should be noted at this point that the transmission of the network availability map to improve energy efficiency can also take place in compressed form. Parts of the network availability map can also be transmitted in successive time periods, thereby taking into account the fact that often only a limited number of bytes can be transmitted and that the conditions with regard to network availability change only very slowly. It can also be provided to transmit only changes to the network availability map from a last known transmission status.

In addition, the cloud 205 or any program element located on a server connected to the cloud 205 can extend and/or update the cloud network availability map 205 using publicly available network coverage maps provided over the Internet by the telecommunications providers.

### REFERENCE NUMBERS

101 sensor, field device, level sensor
102 data acquisition device
103 control device
104 position detection device
105 selection unit
106 first radio communication device
107 second radio communication device
108 first external communication device
109 second external communication device
110, 210 cloud
201, 202 sensor, field device
203, 204 network availability map
205 cloud network availability map
206 operator device
301 startup state
302-320 method steps

1. Field device with at least two different radio communication devices for different radio networks and/or protocols and/or at least one radio communication device with different operating modes and with a control device wherein the field device comprises a position detection device, wherein the control device is designed in such a way to activate one of the radio communication devices and/or an operating mode of the radio communication device depending on a determined position.

2. Field device according to claim 1, wherein the position determination device is designed as a satellite-based position determination device.

3. Field device according to claim 1, wherein the position determination device is suitably designed to evaluate position data provided by a wireless network.

4. Field device according to claim 1, wherein the radio communication devices are selected from the group of radio communication modules that are designed according to one of the standards WLAN™, Bluetooth®, Zigbee®, NB-IoT™, LoRa®, Sigfox®, CAT-M, Z-Wave® and/or others.

5. Field device of claim 1 wherein the field device is set up to determine the availability of a communication network that can be connected by means of a radio communication device from the position data and to select one of the radio communication devices according to the availability.

6. Field device of claim 1 wherein the mode of operation includes a channel selection and/or a setting of a transmit power and/or a setting of a radio protocol.

7. Field device of claim 1 wherein the field device is set up to detect movement of the field device.

8. Field device of claim 1 wherein the field device is designed as a self-sufficient field device.

9. An expansion module for a field device with at least two different radio communication devices for different radio networks and/or protocols and/or at least one radio communication device with different operating modes and a control device wherein the expansion module comprises a position detection device, wherein the control device is designed in such a way to select one of the radio communication devices and/or an operating mode of the radio communication device depending on a determined position.

10. A transportable container comprising a field device, wherein the field device is designed according to claim 1.

11. A method for operating a field device or a field device with an expansion module according to claim 9, comprising the following steps:
a. switching on or activating the field device,
b. determining a position and/or a position signal indicating a position of the field device,
c. determination of radio communication networks available at the position on the basis of the determined position and/or the position signal indicating the position of the field device,
d. activation of one of the radio communication devices and/or an operating mode of the radio communication device depending on the position detected,
e. transmitting and/or receiving data via the radio communication device, and
f. switching off or deactivating the radio communication device and/or field device.

12. A method according to claim 11, wherein position signals of a satellite network are determined for position determination.

13. A method according to claim 10, wherein information from available radio communication networks can be determined for position determination.

14. A method according to claim 10, wherein, in the event that information on available radio communication networks is not available for either the position determined or the position signal, the availability of radio communication networks is determined by activating at least one radio communication device and determining network availability.

15. A method according to claim 14, wherein the determined availability is stored and/or transmitted to a higher-level unit.

16. A method according to claim 15, wherein in addition to the determined availability, a time of the determination is stored.

17. A method according to claim 15, wherein in addition to the determined availability, a reception strength of a signal of the radio communication network is stored.

18. A method according to claim 10, wherein the field device detects movement of the field device and
the steps of position determination and activation depending on the position occur in response to a detected movement and
in the absence of a detected movement, a previously activated radio communication device and/or previously activated operating mode of the radio communication device continues to be used.

19. Computer program code for operating a field device or an expansion module for a field device which, when executed in a processor, causes the processor to carry out the following steps:
a. switching on or activating the field device,
b. determining a position and/or a position signal indicating a position of the field device,
c. determination of radio communication networks available at the position on the basis of the determined position and/or the position signal indicating the position of the field device,
d. activation of one of the radio communication devices and/or an operating mode of the radio communication device depending on the position detected,
e. transmitting and/or receiving data via the radio communication device, and
f. switching off or deactivating the radio communication device and/or field device.
